(19) United States
(12) Patent Application Publication
(10) Pub. No.: US 2024/0127774 A1
(43) Pub. Date: Apr. 18, 2024

(54) Electronic Keyboard with Selectable Diatonic and Jazz Scales

(71) Applicant: Allyn Shell, Silver Spring, MD (US)

(72) Inventor: Allyn Shell, Silver Spring, MD (US)

(21) Appl. No.: 18/047,542

(22) Filed: Oct. 18, 2022

(51) Int. Cl. G10H 1/00; G10C 3/12

(52) U.S. Cl. CPC G10H 1/0016; G10C 3/12

(57) ABSTRACT

This patent is about special scale configurations for electronic keyboards and controls to select them. Currently keyboards are tuned to a well-tempered chromatic scale. This patent presents several alternate scales which can also be selected by the musician. These selectable scales include the current well-tempered chromatic scale, major and minor diatonic scales, major and minor semi-diatonic scales, jazz scales and user specified scales. This patent extends to an electronic component that permits scale selection and produces the pitches for the notes played on a keyboard. This patent also extends to reed instruments such as the melodica and the accordion when capability to select alternate scales is added.

### BACKGROUND OF THE INVENTION

This invention is primarily about electronic keyboard pitches and controls. The following sections describe several types of musical scales and how they differ in the pitches assigned to the notes within the scales.

### PRIOR ART

Electronic keyboards have become very common. Some keyboards are built with a full eight octave set of keys that look exactly like the keys on a piano. The piano makes its sound by a mechanism that directly strikes strings, but a keyboard makes its sound electronically.

The components of an electronic keyboard are not necessarily just one device. They can be spread out in multiple devices. Most obvious is the means for producing musical sounds. Normally a keyboard has some speakers built-in, and the sound production is built into the keyboard and goes straight to the built-in speakers. But, the keyboard may also have an output to send an audio signal to an amplifier which then sends the amplified signal to a set of speakers.

Or in a studio, the keyboard may simply send a MIDI signal to a sound module where it is converted into an audio signal and sent to a sound board that directs the signal to a tract where it is recorded for later manipulation by a producer. Therefore the term “electronic keyboard” could represent a system of electronic devices which collectively comprise all the means described herein. Even the scale selection controls could be under the control of someone other than the musician playing the keyboard.

During the Classical Music era in Europe, the well-tempered scale was perfected, and ever since pianos and keyboards have been tuned to a well-tempered chromatic scale. This allows all keys to sound reasonably in tune without changing the tuning. Even when the modern sound modules such as Auto-Tune do pitch correction, they shift the pitch to the nearest chromatic half-step of a well-tempered chromatic scale. This is done with real-time pitch recognition which is a well-developed art.

Keyboards can be made to associate their keys with different kinds of sounds. Keyboards can be controlled to sound like different instruments or like the wind or like an animal, simply by selecting the sound on the control panel of the keyboard. Other controls can allow the keyboard to transpose the notes being played into a different key, although the scales being played are still all based on the well-tempered chromatic scale. Other controls might be added to allow the keyboard to be tuned to a slightly different pitch or there might be a control to “bend” the pitch for effect like some guitars. The application of these types of pitch generators is straight forward because their electronic production is a well-developed art.

In addition to hand operated controls on a built-in control panel, most keyboards also incorporate foot controls like a piano sustain pedal. Some keyboards have a volume control that is built like the accelerator pedal in a car. Other foot controls have been added similar to the foot controls for a guitar. These foot controls allow the musician to change settings while continuing to use his or her hands for operating the keyboard keys to make music.

### Summary of the Well-Tempered Chromatic Scale Theory

The well-tempered chromatic scale contains twelve half-step intervals. (An interval has two pitches that each has a frequency. The frequencies of a specific interval are related by a characteristic numeric ratio.) The half-step interval of the well-tempered chromatic scale has a ratio that equals the twelfth root of two. A well-tempered major scale contains two whole-steps, a half-step, three whole-steps and another half-step. A minor scale starts on the sixth note of the corresponding major scale.

### Summary of Diatonic Scale Theory

All the tones of a diatonic scale are exact multiples of a fundamental pitch as displayed in FIG. 1. Every harmonic of that tone is an exact multiple of the fundamental pitch. Intervals of one octave have an exact ration of 2/1. (The higher harmonic is named first in the ratio.) So, every multiple of the fundamental pitch that is a power of 2 forms a note that is some octave of the fundamental. The fifth interval is 3/2. The fourth interval is 4/3. The major third interval is 5/4. The minor third is 6/5. Using these intervals, we can construct a diatonic scale.

The fifth is the first diatonic pitch that we will examine. It is very close to seven chromatic half-steps. The diatonic fifth falls exactly on the third harmonic of a fundamental that is the tonic of the diatonic scale. It is about 2% of a chromatic half-step above the corresponding well-tempered note. (NOTE: All offsets from a chromatic half-step are herein given to the nearest whole %. In music theory each % of a chromatic half-step is called a cent. So I will use the ¢ symbol.)

The fourth is next. It is very close to five chromatic half-steps. It is 2¢ below the corresponding well-tempered note (or −2¢). It does not fall on a harmonic of the note that is the tonic of the diatonic scale. Rather the tonic of the diatonic scale falls on the third harmonic of the fundamental for the harmonic series based on the fourth of the diatonic scale. Therefore, the numbers of the harmonics of this fundamental are three times the numbers of the harmonics based on the fundamental which is the tonic of the diatonic scale.

The tonic, the fourth and the fifth are the three notes of the diatonic scale that have major chords within the diatonic scale. A major chord includes the notes that are at intervals of a major third and a fifth above the tonic of the chord. The major third interval is a little less than four chromatic half-steps. It is −14¢ short of four well-tempered chromatic half-steps. That makes the third of the diatonic scale −14¢ below the corresponding well-tempered note. The sixth of the diatonic scale is a major third of the major fourth chord which places it at −16¢ below the corresponding well-tempered note. The seventh of the diatonic scale is a major third of the major fifth chord which places it at −12¢ below the corresponding well-tempered note. The second of the diatonic scale is the fifth of the major fifth chord which places it at 4¢ above the corresponding well-tempered note.

If we select the fourth of the diatonic scale as the fundamental note of the harmonic series used to specify the pitches of the notes, the octaves of this note will be on harmonics 3, 6, 12, 24, 48, etc. The diatonic scale starting on harmonic 24 is composed of the note that fall on harmonics 24, 27, 30, 32, 36, 40, 45 and 48. Compared to the well-tempered notes, the diatonic major scale is at notes that are at 0¢, +4¢, −14¢, −2¢, +2¢, −16¢, −12¢ and 0¢. This type of scale is sometimes called the just temperament.

A diatonic minor scale starts a minor third below the corresponding diatonic major scale. The diatonic minor sixth scale falls on harmonics 40, 45, 48, 54, 60, 64, 72 and 80. The minor scales that start on the second and third of the diatonic major scale do not follow this pattern exactly, When the second is chosen as the tonic of a minor chord or the forth as the tonic of a major chord, the second should be lowered to −18¢. When the third is chosen as the tonic of a minor chord or the fifth is chosen as the tonic of a major chord, the sixth of the diatonic scale should be raised to +6¢. These are the temporarily active scales.

### Summary of Active Scales

When a musical piece is being played, it is played in a basic key, and there is a chord progression that supports the melody of that piece. The different chords in the chord progression each have their own scale (called modes) within the diatonic scale of the basic key being played. There is a minimal difference in the pitches used for these active scales and the basic key. Usually only one note is changed, but that change is large.

FIG. 2 is a Tonnetz Chart of the Diatonic C Scale. The horizontal lines (e.g. D-A) represent an interval of a fifth (3/2=6/4, seven half-steps+2). The left slanting diagonal lines (e.g. D-F) represent an interval of a minor third (6/5, three half-steps +16¢). The right slanting diagonal lines (e.g. F-A) represent an interval of a major third (5/4, four half-steps −14¢). In this Tonnetz Chart, the triangles that point up (with upper case roman numerals) are major chords, and the triangles that point down (with lower case roman numerals) are minor chords.

There are two ways to take a diatonic whole-step. It can be two lines directly to the right or diagonally up and to the left through a major chord triangle and a minor chord triangle. The diatonic half-step is always diagonally down and to the left through a minor chord triangle and a major chord triangle. The C diatonic scale centers on the C major chord: C (two right) D (up left) E (down left) F (two right) G (up left) A (two right) B (down left) C.

This chart has two extra notes: D and A. They are used in the active scales. Notably, the D in the upper left and the D in the lower right have pitches that differ by 22¢ (sometimes called a comma). Similarly, the A in the upper left and the A in the lower right have pitches that differ by 22¢.

There are the three major chords and three minor chords. Each of the minor chords is associated with one of the major chords and shares its active scale. So there are only three active scales associated with a basic scale. The active scale for the tonic scale is called the lonian mode. It is the basic diatonic scale. Its corresponding minor scale, called the Aeolian mode, uses the same notes as the basic diatonic scale. So the active scale for the lonian and Aeolian modes is the basic diatonic scale with no altered pitches.

The active scale for the major fourth chord is called the Lydian mode. Its corresponding minor scale is called the Dorian mode. The only difference between the notes of the basic diatonic scale and the Lydian or Dorian mode is that the second note of the diatonic scale is lowered by 22¢ to be a minor third below the tonic of the major forth chord. So the second will be lowered from +4¢ to −18¢. All the other notes remain on their basic diatonic tones. This gives a scale pattern for the F Lydian mode scale centered on the F major chord: F (two right) G (up left) A (two right) B (down left) C (up left) D (two right) E (down left) F.

The active scale for the major fifth chord is called the Mixolydian mode. Its corresponding minor scale is called the Phrygian mode. The only difference between the notes of the basic diatonic scale and the Mixolydian or Phrygian mode is that the sixth note of the diatonic scale is raised to be a major second from the tonic of the major fifth chord. So the sixth will be raised from −16¢ to +6¢. All the other notes remain on their basic diatonic tones. This gives a scale pattern for the G Mixolydian mode scale centered on the G major chord: G (two right) A (up left) B (down left) C (two right) D (up left) E (down left) F (two right) G.

There is one other chord tonic in a diatonic scale, and that is based on the seventh note of the diatonic scale. This chord is neither major nor minor; it is diminished. The active scale for this chord is called the Locrian mode. This chord is rarely used. The most common alternate is the major fifth with the minor seventh of the chord added. (On the Tonnetz chart that would be down and to the right from the right D which is like putting a tail on the major chord triangle.) When that is done the active scale for the Mixolydian mode is used. When the diminished seventh chord is actually used, an extra note is sometimes substituted in the chord which is the sharp fifth of the diatonic scale. This note would be at harmonic 12&2/3. This is very close to the eighth chromatic half-step and makes a good choice for the sharp fifth.

### Summary of Semi-Diatonic Scale Theory

We have learned from classical music that a well-tempered chromatic scale does not sound too bad. The ear can accept the slight divergence from the harmonious tones of a diatonic scale. So it is possible to get close to a diatonic scale simply by adjusting notes 3, 6 and 7 of the well-tempered chromatic by −14¢ to form a semi-diatonic scale. The second note of the semi-diatonic scale should also be adjusted by −14¢ when playing a minor 2nd chord. The semi-diatonic scale is a variation of the diatonic scale that is most useful for non-electronic instruments such as a melodica or accordion. These instruments form their sound by passing air across a reed. Every note of a semi-diatonic scale is within 4¢ of a diatonic scale note, and it only requires one extra reed (at −14¢) per note. Compared to the well-tempered notes, the semi-diatonic major scale is at notes that are at 0¢, 0¢, −14¢, 0¢, 0¢, −14¢, −14¢ and 0¢. On the Tonnetz Chart that would be like all the notes of the lower row being on their well-tempered chromatic tone, and all the notes of the upper row being lowered 14¢.

Active scales still apply, but the difference between the D and A in the upper left and their corresponding pitches in the lower right are 14¢ rather than 22¢.

The corresponding semi-diatonic minor scale starts on the sixth of the semi-diatonic major scale. Compared to the well-tempered notes, the semi-diatonic minor scale is at notes that are at −14¢, −14¢, 0¢, 0¢, −14¢, 0¢, 0¢ and −14¢.

### Summary of Jazz Scale Theory

If we select the tonic of the diatonic scale as the fundamental note of the harmonic series used to specify the pitches of the notes, the diatonic scale starting on harmonic 8 is composed of the notes that fall on harmonics 8, 9, 10, 10&2/3, 12, 13&1/3, 15 and 16. This is the diatonic scale that appears as the left octave in FIG. 1 as solid diamonds (for the whole numbered harmonics) and solid triangles (for the fractional numbered harmonics). The diatonic scale that appears as right octave of FIG. 1 is composed of the notes that fall on harmonics 16, 18, 20, 21&1/3, 24, 26&2/3, 30 and 32.

The whole numbered harmonics that are not part of the diatonic scale are called jazz notes, especially (7), 11, 13, 14, 17 and 19. These notes appear as part of the first octave and a third of FIG. 1 as open diamonds. The jazz scale falls exactly on the harmonics of the tonic: 8, 9, 10, 11, 12, 13, 14, 15 and 16, and notably, a jazz scale contains eight notes rather than seven notes. Harmonics 17 and 19 can also be considered part of the jazz scale. When these are included there are ten notes in the jazz scale on harmonics of the tonic 16, (17), 18, (19), 20, 22, 24, 26, 28, 30 and 32.

### Summary of User Defined Scales

A user defined scale can be a variation on a predefined scale type or a whole new mapping of keyboard keys to designated pitches. For instance, the diatonic scale only defines seven of the twelve keyboard keys in an octave. Of the five extra keyboard keys three have obvious mappings to the jazz 7th, 17th and 19th. The two other notes F# and G# in the C major scale are available for different mappings based on a musical piece's requirements or the musician's choice. The jazz 11th and the jazz 13th are certainly reasonable default mappings, but 12&2/3 also has a reasonable claim to the G# keyboard key so should be a possible choice.

Please note that the tonic of a user specified scale is not necessarily the same note as the fundamental of the scale. The fundamental of a diatonic scale is its fourth.

Alternately, the user might like to have all the harmonics from 1 to 32 mapped to all the sequential white keys for four and a third octaves like a super jazz scale. Or maybe even up to 48 to allow the diatonic scale to be “discovered” within a musical piece. This is a direct mapping of pitches to keyboard keys. It does not represent a basic scale that can be transposed to other keys. So this type of special user defined scale does not have a basic key or active keys. It is simply a direct mapping.

The user might like to use 24 keyboard keys for each octave and use a quarter-step per note as in some Arabic music. Or the user might like to try 31, 41, 45, 53, 70, 72, 84 equally spaced notes per octave each of which as has been tried in the art. Or the user might like to try poly-tonal pitches in a pentatonic scale to get a more oriental sound.

In the early days of classical music, many different tunings were explored before the well-tempered chromatic scale took over. These different tunings allowed the different musical pieces to have their own characteristic sound. A lot of that distinctive character has been lost by the dominance of the well-tempered chromatic scale, but user defined scales can let those pieces recover their original character.

The electronic keyboard should be able to let the user specify what note pitch (or pitches) he or she wants to map to any note of a scale. The user should then be able to store a set of these choices as a user specified scale, and to retrieve it later for use, transposing it to suit a particular piece of music.

The electronic keyboard should also permit the user to copy these user specified scales for the keyboard onto electronic storage media and then store them back onto a compatible keyboard. Once on a keyboard, the user should be able to transpose that scale mapping in any basic key. If the scale is such that the chords used in the basic key favor using alternate pitches for certain note of the chord then the user should be able to specify, store and retrieve these alternate mapping as part of a user defined active scale specification.

### BRIEF DESCRIPTION OF DRAWINGS

FIG. 1 illustrates two rows of logarithmically spaced pitches that represent musical scales. The lower row is a two-octave well-tempered chromatic scale. These pitches correspond to the pitches produced by the keys on a traditional piano keyboard. The upper row contains both a two octave diatonic scale represented by solid diamonds and solid triangles and a jazz scale represented by solid diamonds and hollow diamonds. These jazz scale notes all fall on pitches that are exact (whole number) multiples of a fundamental pitch. The asterisks that appear in the lower (left) octave are fractional multiples of the fundamental pitch (8&1/2, 9&1/2), but they are exact multiples of the fundamental pitch in the upper (right) octave. The asterisks that appear in the upper (right) octave represent exact multiples of the fundamental pitch that are rarely used in musical pieces.

FIG. 1 LEGEND

| SYMBOL | TYPE | UPPER ROW HARMONICS |
|---|---|---|
| ♦ | Diatonic Notes | 8, 9, 10, 12, 15, 16, 18, 20, 24, 30, 32 |
| ⋄ | Jazz Notes | 11, 13, 14, 17, 19, 22, 26, 28 |
| ▴ | Non Jazz Diatonic | 10&2/3, 13&1/3, 21&1/3, 26&2/3 |
| * | Extra Jazz Notes | 8&1/2, 9&1/2, 21, 23, 25, 27, 29, 31 |

FIG. 2 displays a Tonnetz Chart of the Diatonic C Scale. The horizontal lines (e.g. D-A) represent an interval of a fifth. The left slanting diagonal lines (e.g. D-F) represent an interval of a minor third. The right slanting diagonal lines (e.g. F-A) represent an interval of a major third.

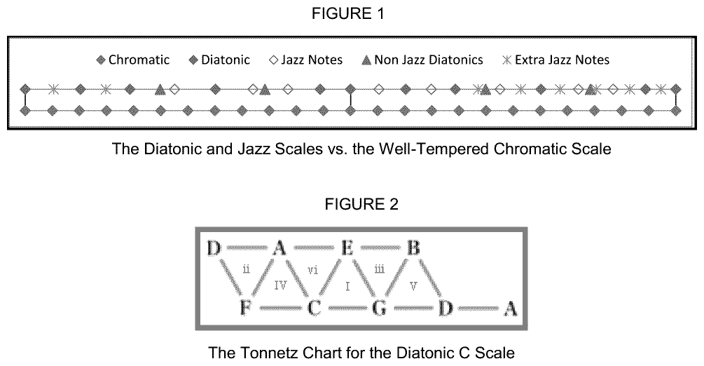

### SUMMARY OF THE INVENTION

The primary embodiment of this invention is as part of a sound module, an electronic musical component (which could be a software program like Auto-Tune) typically used in a studio. This embodiment can put the controls that select the scale type, basic key and active key under the control of the producer in the studio rather than the musician. This allows the application of selected scales to be applied to a piece by the recording engineer while the musician is playing.

Alternately the musician would use a standard keyboard that generates a MIDI signal, and the producer would record that to a master. Then the producer could use the primary embodiment to select the scale type and basic key at a later time while he is producing the piece.

The preferred alternate embodiment of this invention is an electronic keyboard with an internal sound module with selectable scale types. Prior to playing a musical piece, the musician selects the specific scale type and the specific key that should be used for the piece from the keyboard control panel. This pre-performance selection associates specific pitches to each keyboard key. So the basic key is specified, and the active key will default to the basic key.

During the process of playing the musical piece, the user will also operate the standard sustain pedal and an active key selection activation pedal. Each time the active key selection activation pedal is pressed the electronics in the keyboard will analyze the notes being played and automatically select the active key for use until the next time the active key selection activation pedal is pressed. The selection activation pedal will typically be used alternately with the sustain pedal.

Whether the controls are on the keyboard control panel under the musician's control or in a separate part of a system of electronic devices, the ability to select a scale type is the central part of the preferred embodiment of this patent. On a keyboard control panel it could take the form of a list displayed on a touch screen. The selection of the scale type should be clearly displayed on the screen after being selected. If the selected scale is transposable (rather than a direct mapping) the basic key could be specified by playing a note or a chord on the keyboard. The basic key selection will be displayed on the screen with the scale type.

User defined scales can be created and added to the list of choices. The preferred embodiment will be able to store and retrieve user defined scale definitions. These definitions will also be transferrable to other compatible keyboards or electronic devices.

Another embodiment of this invention applies to the accordion, reed organ and melodica using semi-diatonic scales. These can also be modified to play alternate scales with the addition of a little electronics and/or by use of a semi-diatonic scale to allow these instruments to be more harmonious. A semi-diatonic scale only requires one extra reed per note. Selection of that reed can be actively controlled by control panel buttons. (The mechanics for switching between two different reeds for the same note is a well-developed art used in reed organs and harmonicas. In the harmonica the selection is made by breathing in or out. In reed organs the selection is made by electronic or mechanical linkages from keys and other buttons or stops.) NOTICES

The term “key” has two different meanings in the following claims. When prefaced by the word “keyboard”, “key” refers to a physical key like the black and white keys on a piano keyboard; When prefaced by the word “basic” or the word “active”, “key” refers to the name of the tonic of a musical scale.

The “fundamental” is not necessarily the same as the “tonic”.

Within these claims “plurality” means “one or more”. Therefore, the following disclaimer is necessary to clarify “the well-tempered chromatic scale in the plurality of types of musical scales” of claim 1.

### WHAT IS DISCLAIMED

This patent disclaims any electronic component of claim 1 wherein the plurality of types of musical scales is composed of only the well-tempered chromatic scale.

What is claimed:

1. An electronic component comprising a means for selecting a type of scale from a plurality of types of musical scales comprising one or more of the following scale types a well-tempered chromatic scale, a diatonic major scale, a diatonic minor scale, a semi-diatonic major scale, a semi-diatonic minor scale, a jazz scale or a plurality of user defined scales.

2. An electronic component of claim 1 further comprising a means for selecting a basic key for said selected type of musical scale.

3. An electronic component of claim 2 wherein the means for selecting the basic key further comprising a default means for maintaining the previously selected basic key.

4. An electronic component of claim 2 further comprising a means for selecting an active key from said basic key's musical scale.

5. An electronic component of claim 4 wherein the means for selecting the active key further comprising an active key selection process.

6. An electronic component of claim 5 wherein the active key selection process further comprising a method for recognizing the chord played.

7. An electronic component of claim 1 wherein the means for specifying user defined scales further comprising a means for mapping a plurality of pitches to individual keyboard keys.

8. An electronic component of claim 1 wherein the means for specifying user defined scales further comprising a means for mapping a plurality of pitches to individual scale notes.

9. An electronic component of claim 8 wherein the means for mapping said pitches further comprising a means for specifying the harmonic interval with respect to the fundamental for said scale.

10. An electronic component of claim 8 wherein the means for mapping said pitches further comprising a means for specifying a number of well-tempered chromatic half-steps with additional percentage offset to said scale pitch.

11. An electronic component of claim 1 wherein the means for specifying user defined scales further comprising a means for storing and for retrieving said scale.

12. An electronic component of claim 11 wherein the means for specifying user defined scales further comprising a means for exporting and for importing one or more said stored scales.

13. An electronic component of claim 1 further comprising a means for producing musical sounds for the pitches associated with the notes of said selected scale.

14. An electronic musical instrument comprising the electronic component of claim 1 and a means to play a plurality of notes of said selected scale.

15. An electronic musical instrument of claim 14 wherein the means to play said plurality of notes further comprising a keyboard with individual keyboard keys for each note of said scale.

16. An electronic musical instrument of claim 15 wherein the means to play said plurality of notes further comprising a means for producing musical sounds for the individual pitches associated with the said notes.

17. An electronic musical instrument of claim 16 wherein the means to select the said scale type further comprising a control panel component.

18. An electronic musical instrument of claim 17 wherein the means to select a basic key further comprising a method to specify said basic key by playing one keyboard key or one chord.

19. An electronic musical instrument of claim 18 wherein the means to select the active key further comprising an active key selection process.

20. An electronic musical instrument of claim 19 wherein the active key selection process further comprising a foot pedal activation.
